(19) United States
(12) Patent Application Publication
(10) Pub. No.: US 2025/0225414 A1
(43) Pub. Date: Jul. 10, 2025

(54) AI AGENT DECISION MAKING UNDER RISK BASED ON A SPECIFICATION OF THE PROBABILITY SPACE

(71) Applicant: SRI International, Menlo Park, CA (US)

(72) Inventors: Erfaun Noorani, Fairless Hills, PA (US); Shantanu Rane, Palo Alto, CA (US)

(21) Appl. No.: 19/000,237

(22) Filed: Dec. 23, 2024

Related U.S. Application Data
(60) Provisional application No. 63/618,701, filed on Jan. 8, 2024.

(51) Int. Cl. G06N 5/04; G06N 20/00

(52) U.S. Cl. CPC G06N 5/04; G06N 20/00

(57) ABSTRACT

In an example, a method for decision-making by an Artificial Intelligence (AI) agent based on risk attitude includes processing an explored state space of an environment to identify one or more potential outcomes for each of a plurality of potential decisions; assigning, based on a utility function, a utility value to each of the one or more potential outcomes for each of the plurality of potential decisions, wherein the utility function depends on a risk parameter indicative of a specified risk preference of the AI agent; determining, based on a predefined sigma algebra defining a set of events that may occur in the environment, a probability of each of the one or more potential outcomes occurring for each of the plurality of potential decisions; selecting a decision from the plurality of potential decisions based on the utility values and the probabilities; and outputting an indication of the decision.

This application claims the benefit of U.S. Patent Application 63/618,701, filed Jan. 8, 2024, which is incorporated by reference herein in its entirety.

### TECHNICAL FIELD

This disclosure is related to machine learning systems, and more specifically to decision making by artificial intelligence (AI) agents.

### BACKGROUND

Risk attitude refers to a preference of an individual or system for risk or certainty. Risk attitude may be an important factor in decision-making, for risk attitude may influence how people weigh potential gains and losses. In many traditional decision-making machine learning models, particularly those based on expected utility theory, the notion of risk attitude often fails to be explicitly incorporated into the model. The expected utility approach inherently incorporates risk, for this approach considers the uncertainty associated with different outcomes. However, it should be noted that expected utility is a risk-neutral measure.

### SUMMARY

Traditional expected utility approaches do not explicitly account for a preference of a decision maker for risk or risk aversion. When dealing with multiple sources of uncertainty, such as, but not limited to, random variables and risk factors, the principle of iterated expectations applies. The principle of iterated expectations may enable breaking down complex expectations into simpler ones. In other words, in the context of risk factors, iterated expectations may lead to elimination of the risk factors from the optimization problem because, once the risk factor is conditioned to calculate the expected utility, the risk factor itself may become deterministic within that conditional expectation. While traditional models may not explicitly consider risk attitude, real-world decision-makers often exhibit risk-averse or risk-seeking behavior in view of expected rewards.

In general, techniques are described for a machine learning system that implement decision making under risk based on a specification of the probability space. The probability space may be that of the decision maker. In the realm of Artificial Intelligence (AI), decision-making often involves uncertainty. To model this uncertainty, in accordance with the disclosed techniques, probability theory may be employed to specify the probability space to the machine learning system. In some examples, the probability space is specified using a sigma algebra (o-algebra). The term “sigma algebra” refers to a collection of subsets of a sample space that satisfies certain properties. A sigma algebra may be used to define the set of events to which probabilities are assigned, and in this way the sigma algebra can specify the probability space.

In traditional decision-making models, like expected utility theory, decisions are often made based on maximizing expected utility. However, this approach may not explicitly account for risk preferences. To address this, a machine learning system implementing the disclosed techniques may use special utility functions that account for the specification of the probability space to incorporate risk attitudes into the decision-making process. Risk-sensitive utility functions are designed to capture the impact of risk on decision-making.

A machine learning system implementing the disclosed techniques may be designed to make AI decisions, but the machine learning system may employ a flexible approach to evaluate the potential outcomes. In some examples, this flexibility may be achieved by the machine learning system through different definitions of the utility function. In this way, a utility function may be a tool that measures the “happiness” or “satisfaction” associated with a particular outcome. A higher utility corresponds to a better outcome. In one aspect, the machine learning system may employ an exponential utility function. The disclosed exponential utility techniques may assign exponentially decreasing utility to losses. In another aspect, the machine learning system may employ a combination of the expected utility and the variance of the utility function.

The techniques may provide one or more technical advantages that realize at least one practical application. For example, the disclosed techniques may address limitations in traditional models by providing risk management in AI decision-making. Such improvement in the technical field of AI decision-making, in particular to AI agents, may be achieved by defining utility functions and incorporating risk parameters, which may enable AI agents to make more informed and nuanced decisions. In some cases, by adjusting the risk parameter, the disclosed techniques may make an AI agent more cautious, prioritizing safety and avoiding high-risk options. Conversely, a higher risk parameter may encourage the AI agent to take bolder actions, aiming for potentially higher rewards.

In an example, a method for decision-making by an Artificial Intelligence (AI) agent based on risk attitude includes processing, by the AI agent, an explored state space of an environment to identify one or more potential outcomes for each of a plurality of potential decisions; assigning, by the AI agent, based on a utility function, a utility value to each of the one or more potential outcomes for each of the plurality of potential decisions, wherein the utility function depends on a risk parameter indicative of a specified risk preference of the AI agent; determining, by the AI agent, based on a predefined sigma algebra defining a set of events that may occur in the environment, a probability of each of the one or more potential outcomes occurring for each of the plurality of potential decisions; selecting, by the AI agent, a decision from the plurality of potential decisions based on the utility values and the probabilities; and outputting, by the AI agent, an indication of the decision.

In an example, a computing system for decision-making by an Artificial Intelligence (AI) agent based on risk attitude, the computing system including: processing circuitry in communication with storage media, the processing circuitry configured to execute a machine learning system comprising the AI agent, the machine learning system configured to: process an explored state space of an environment to identify one or more potential outcomes for each of a plurality of potential decisions; assign, based on a utility function, a utility value to each of the one or more potential outcomes for each of the plurality of potential decisions, wherein the utility function depends on a risk parameter indicative of a specified risk preference of the AI agent; determine, based on a predefined sigma algebra defining a set of events that may occur in the environment, a probability of each of the one or more potential outcomes occurring for each of the plurality of potential decisions; select a decision from the plurality of potential decisions based on the utility values and the probabilities; and output an indication of the decision.

In an example, non-transitory computer-readable storage media having instructions encoded thereon for decision-making by an Artificial Intelligence (AI) agent based on risk attitude, the instructions configured to cause processing circuitry to: process an explored state space of an environment to identify one or more potential outcomes for each of a plurality of potential decisions; assign, based on a utility function, a utility value to each of the one or more potential outcomes for each of the plurality of potential decisions, wherein the utility function depends on a risk parameter indicative of a specified risk preference of the AI agent; determine, based on a predefined sigma algebra defining a set of events that may occur in the environment, a probability of each of the one or more potential outcomes occurring for each of the plurality of potential decisions; select a decision from the plurality of potential decisions based on the utility values and the probabilities; and output an indication of the decision.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 illustrates an example reinforcement learning system for training an agent to interact with an environment, in accordance with the techniques of the disclosure.

FIG. 2 is a detailed block diagram illustrating an example computing system, in accordance with the techniques of the disclosure.

FIG. 3 is a flowchart illustrating an example mode of operation for a reinforcement learning system, according to techniques described in this disclosure.

Like reference characters refer to like elements throughout the figures and description.

### DETAILED DESCRIPTION

In traditional decision-making, especially when using expected utility theory, the goal is to maximize the expected value of a certain outcome. This approach inherently assumes a risk-neutral stance. The risk-neutral stance means that the decision-maker may be indifferent to risk. The decision-maker may only be concerned with the average outcome, not the variability around that average. Additionally, iterated expectation is a property of expectation that the expectation of an expectation is simply the expectation itself. In other words, even if the decision-maker conditions the expected utility on a risk factor, when the decision-maker takes the expectation over the risk factor, the risk factor is eliminated from the final objective function.

In one non-limiting example, a Machine Learning (ML) system takes a more nuanced technique by employing utility functions that explicitly account for risk. In one example, the disclosed techniques may allow for a more refined decision-making process, especially when dealing with uncertain and potentially risky situations. Risk-sensitive utility functions may go beyond the simple expectation of utility. The risk-sensitive utility functions may consider factors like the variance or higher moments of the utility distribution, which may capture the riskiness of the outcomes.

By incorporating risk factors into the utility function, the disclosed system may ensure that the risk remains a relevant consideration throughout the optimization process. In the disclosed system risk is not just a one-time consideration but an ongoing factor influencing decisions. In many real-world scenarios, risk aversion or risk-seeking behavior may be important. For example, in finance, investors may prefer lower-risk investments, while in certain entrepreneurial ventures, a higher risk tolerance might be desirable.

AI agents may benefit from the disclosed techniques by making more informed decisions that align with specific risk preferences. This may lead to more robust and reliable AI systems.

The disclosed system and method address the challenge of integrating risk considerations into AI decision-making.

The disclosed system may achieve integration of risk considerations into AI decision-making by introducing flexible utility functions that may be tailored to specific risk preferences. By employing utility functions that penalize losses more heavily, the AI agent may be made more cautious, prioritizing safety and avoiding high-risk options. Conversely, utility functions that reward high-potential gains may encourage the AI agent to take bolder actions, aiming for potentially higher rewards. The disclosed system may allow for fine-tuning the risk tolerance of the AI agent through parameters within the utility functions. This may enable the AI agent to adapt to changing circumstances or specific task requirements.

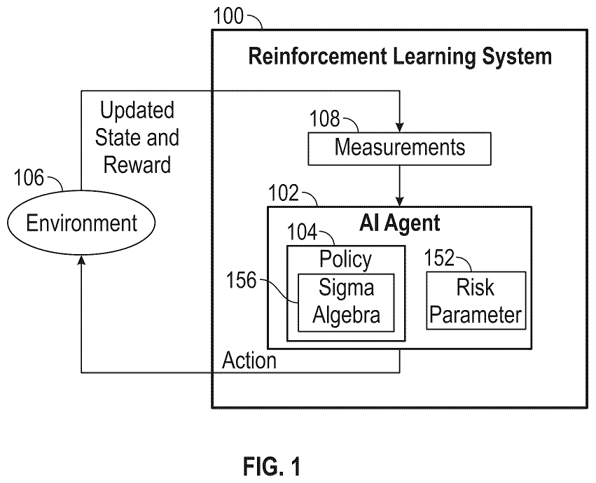

FIG. 1 illustrates an example reinforcement learning system for training an agent to interact with an environment, in accordance with the techniques of the disclosure.

The reinforcement learning system 100 may include an AI agent 102 that determines actions based on a policy 104. Each time an action is determined, it is output to an environment 106 being controlled by the AI agent 102. The action may update a state of the environment 106. The updated state may be returned to the reinforcement learning system 100 along with an associated reward for the action. The received information may be used by the reinforcement learning system 100 to determine the next action. In general, the reward may be a numerical value. The reward may be based on any event or state of the environment 106. For example, the reward may indicate whether the AI agent 102 has accomplished a task (e.g., navigating to a target location in the environment 106) or the progress of the AI agent 102 towards accomplishing a task.

The policy 104 may define how the system performs actions based on the state of the environment 106. As the reinforcement learning system 100 is trained based on a set of measurements 108, the policy 104 followed by the AI agent 102 may be updated by assessing the value of actions according to an approximate value function or a return function to improve the expected return from the actions taken by the policy 104. This is typically achieved by a combination of prediction and control to assess the success of the actions performed by the AI agent 102, sometimes referred to as the “return”. The return may be calculated based on the rewards received following a given action. For instance, the return might be an accumulation of multiple reward values over multiple time steps.

In an aspect, the state space, action space, transition function, and reward function may be derived from a domain model. A domain model is a representation of the knowledge about a particular domain. The domain model may be represented in a variety of ways, such as, but not limited to a set of rules, a graph, or a machine learning framework such as a neural network. The state space may be the set of all possible states that the reinforcement learning system 100 can be in. As the reinforcement learning system 100 explores (visits) the state space, the system may learn about the relationships between the different states, referred to herein as explored state space.

The AI agent 102 may perform a first action within the environment 106. This action can be anything, such as moving to a new location, taking a measurement, or interacting with an object. Next, the reinforcement learning system 100 may obtain one or more measurements from the environment 106. These measurements 108 (collectively referred to as “experiences”) may be used to update the topology of the explored state space. Next, the reinforcement learning system 100 may update the topology of the explored state space of a domain model for the environment based at least in part on the one or more measurements. For example, if a robot is exploring a new environment, the robot may use sensors to collect measurements of surroundings. These measurements may be used to create a state space that represents all of the possible configurations of the robot and the corresponding environment (e.g., environment 106). As the robot explores, the robot may collect new measurements and use them to update the state space. The update may involve adding new states to the state space, removing states that are no longer possible, or updating the weights of connections between states. The topology of the explored state space may be a representation of the relationships between different states of the domain model. The measurements may be used to update the values associated with each of the states in the topology. In an aspect, the reinforcement learning system 100 may select, based at least in part on the updated topology, a second action to be performed by the AI agent 102 within the environment 106. The second action may be chosen in a way that is likely to maximize the reward that the reinforcement learning system 100 receives and taking risk factors into consideration, as described below. In an aspect, the second action may be chosen based on the policy 104. Next, the agent 102 may perform the second action within the environment 106. As shown in FIG. 1, the process may be repeated, with the reinforcement learning system 100 continuously updating its knowledge of the environment 106 and selecting actions in a way that maximizes its reward, while also considering the risk associated with different decisions.

In other words, when the agent 102 performs a number of actions within the environment 106, the reinforcement learning system 100 may be exploring the state space of the domain model. The state space may be the set of all possible states that the reinforcement learning system 100 can be in. As the reinforcement learning system 100 explores the state space, it may learn about the relationships between the different states. This knowledge may be used by the reinforcement learning system 100 to generate and/or update the topology of the explored state space. The topology of the explored state space is a representation of the relationships between the different states. The topology may be represented as a graph, with each state represented as a node and the edges between the nodes representing the possible transitions between states. The topology may be used to understand the structure of the state space and to plan future actions. This knowledge may be used by the reinforcement learning system 100 to solve a variety of problems, such as, but not limited to, finding the shortest path between two states, finding the best way to avoid obstacles, playing games, evaluating financial or trading decisions, optimizing healthcare treatments, allocating resources and other logistics problems, autonomous vehicle or device decision-making, industrial automation, natural language processing and chatbot operation, marketing and personalization, or scientific research.

As described herein, actions attributed to an AI agent 102, RL system, or other system may include the AI agent 102 causing or otherwise interacting with some other system to perform such actions. For example, a description of an AI agent 102 or an RL system “performing” an action encompasses an action of AI agent 102 or the RL system to cause a robot or other system to perform the action. As another example, AI agent 102 or an RL system “obtaining” a measurement encompasses AI agent 102 receiving an indication of a measurement taken by a sensor of a robot or other system.

The AI agent 102 may be calibrated to offset any inherent biases or risk preferences of the human modeler, ensuring more objective decision-making. Alternatively, the AI agent 102 may be designed to mimic the risk attitude of the human modeler, creating a more harmonious and collaborative relationship.

In accordance with the disclosed techniques, a sigma algebra 156, a fundamental concept in probability theory, defines the set of events that may occur and is used to specify the probability space for AI agent 102. In the context of AI decision-making, the specific choice of sigma algebra 156 may significantly impact the risk profile of the AI agent 102. In an aspect, the sigma algebra 156 may be included in the policy 104.

A finer-grained sigma algebra 156 may allow for more precise information about the state of the environment 106. In one example, the finer-grained sigma algebra 156 may lead to more accurate risk assessments and potentially more informed decisions. However, the finer-grained sigma algebra 156 may also increase the complexity of the decision-making process and potentially expose the AI agent 102 to more nuanced risks. By carefully selecting the sigma algebra 156, the AI agent 102 may control exposure to different types of risk. For example, a coarser-grained sigma algebra 156 may help the AI agent 102 focus on high-level risks, while a finer-grained sigma algebra 156 may allow AI agent 102 to consider more granular risks. While the direct selection of sigma algebra 156 based on risk preference may not be explicit, the underlying concept is the careful consideration of the events that the AI agent 102 deems relevant.

In an example, the risk attitude of AI agent 102, whether risk-averse or risk-seeking, may influence the choice of sigma algebra 156. A risk-averse AI agent 102 may prefer a coarser-grained sigma algebra 156 to avoid unnecessary complexity and potential risks. In contrast, a risk-seeking AI agent 102 may prefer a finer-grained sigma algebra 156 to identify opportunities that may be missed with a coarser-grained techniques. As a concrete example, consider AI agent 102 making investment decisions. The sigma algebra 156 may be defined in various ways. Coarse-grained sigma algebra 156 may define events such as, but not limited to, “market up,” “market down,” or “market stable.” Fine-grained sigma algebra 156 may define events like “specific stock price increase,” “specific bond yield decrease,” or “specific geopolitical event.” A risk-averse AI agent 102 may prefer the coarser-grained sigma algebra 156 to avoid the complexity of analyzing individual stocks and bonds. A risk-seeking AI agent 102, however, may prefer the finer-grained sigma algebra 156 to identify potential high-return opportunities.

In traditional decision-making, AI agents often optimize their choices based on expected utility, which is a risk-neutral approach. However, the disclosed system may employ techniques that allow for more nuanced risk considerations. Such techniques may incorporate a risk parameter 152 into special utility functions. Accordingly, the special utility functions may be designed to capture the attitude of the AI agent 102 towards risk, as described below.

In summary, FIG. 1 illustrates reinforcement learning system 100 configured to utilize a sophisticated AI decision-making process that involves the steps described below. The AI agent 102 may first analyze the possible scenarios or states of environment 106. This step may involve identifying all potential outcomes that could arise from a plurality of different decisions. The AI agent 102 may assign a value, or utility, to each potential outcome. This utility value may represent the desirability of that outcome from the perspective of the AI agent 102. An important factor in the decision-making process is a risk parameter 152. The risk parameter 152 may reflect the tolerance of the AI agent 102 for risk. A higher risk parameter 152 may mean the AI agent 102 is more willing to take chances for potentially higher rewards. The AI agent 102 may calculate the likelihood of each potential outcome occurring. This step may involve defining a probability space, which may include sigma algebra 156 that specifies the set of possible events. The AI agent 102 may make a decision by considering both the utility and probability of each potential outcome. Advantageously, AI agent 102 may select the decision that maximizes the expected utility, taking into account the risk preference of the AI agent 102, as specified by the risk parameter 152 and accounting for the probability space specified by the sigma algebra 156. Finally, AI agent 102 may communicate (e.g., output) an indication of the chosen decision to the external environment or may execute the chosen decision directly by performing a certain action, for example.

In this way, the AI agent 102 may make informed decisions by understanding the potential consequences of different actions and evaluating the desirability of these outcomes. The AI agent 102 may assess the likelihood of each outcome to balance risk and reward to select the optimal choice.

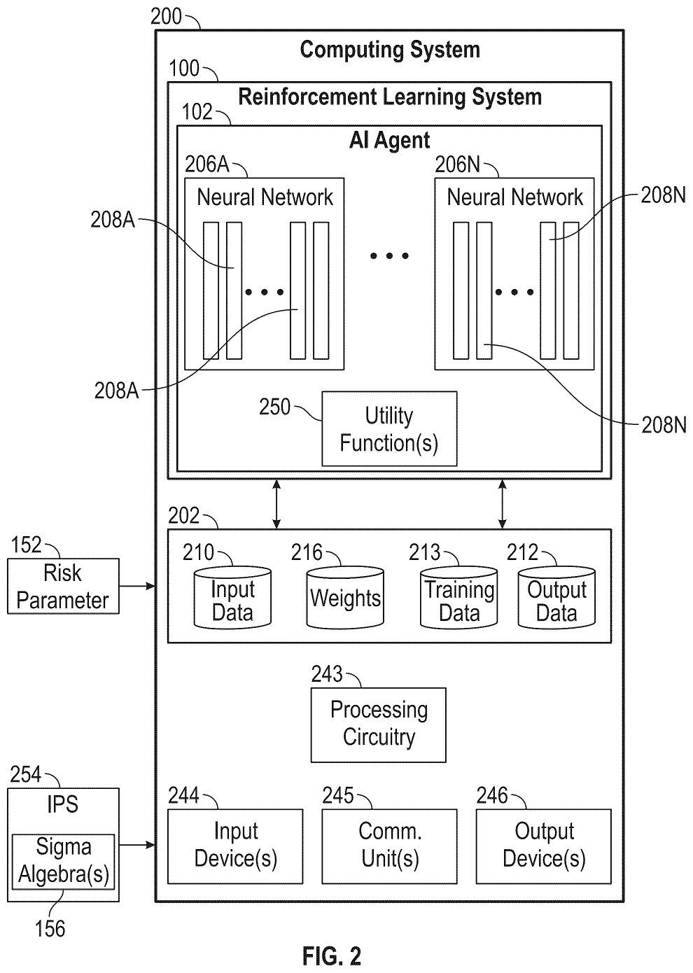

FIG. 2 is a block diagram illustrating an example computing system 200. Computing system 200 implements an example instance of RL system 100 of FIG. 1. As shown, computing system 200 includes processing circuitry 243 and memory 202 for executing a reinforcement learning system 100 having one or more neural networks 206A-206N (collectively, “NNs 206”) comprising respective sets of layers 208A-208N (collectively, “layers 208”). Each of NNs 208 may comprise various types of neural networks, such as, but not limited to, recursive neural networks (RNNs), convolutional neural networks (CNNs) and deep neural networks (DNNs). In an aspect, any of NNs 206 may comprise an example instance and implementation of the AI agent 102 shown in FIG. 1. However, implementations of AI agent 102 using machine learning models other than NNs may be used. For example, AI agent 102 may implement reinforcement learning using tabular models, linear models such as linear function approximators, decision trees, Gaussian processes, evolutionary algorithms, probabilistic models such as Bayesian networks or Hidden Markov models, etc.

Computing system 200 may be implemented as any suitable computing system, such as one or more server computers, workstations, laptops, mainframes, appliances, cloud computing systems, High-Performance Computing (HPC) systems (i.e., supercomputing) and/or other computing systems that may be capable of performing operations and/or functions described in accordance with one or more aspects of the present disclosure. In some examples, computing system 200 may represent a cloud computing system, a server farm, and/or server cluster (or portion thereof) that provides services to client devices and other devices or systems. In other examples, computing system 200 may represent or be implemented through one or more virtualized compute instances (e.g., virtual machines, containers, etc.) of a data center, cloud computing system, server farm, and/or server cluster. In other examples, computing system 200 may represent a controller, embedded system, implantable medical device, chatbot system, autonomous vehicle, or any other type of device or system that implements or relies on reinforcement learning.

The reinforcement learning system 100 may further include one or more utility functions 250 described below.

In some examples, at least a portion of system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

The techniques described in this disclosure may be implemented, at least in part, in hardware, software, firmware or any combination thereof. For example, various aspects of the described techniques may be implemented within processing circuitry 243 of computing system 200, which may include one or more of a microprocessor, a controller, a digital signal processor (DSP), an application specific integrated circuit (ASIC), a field-programmable gate array (FPGA), or equivalent discrete or integrated logic circuitry, or other types of processing circuitry. Processing circuitry 243 of computing system 200 may implement functionality and/or execute instructions associated with computing system 200. Computing system 200 may use processing circuitry 243 to perform operations in accordance with one or more aspects of the present disclosure using software, hardware, firmware, or a mixture of hardware, software, and firmware residing in and/or executing at computing system 200. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Memory 202 may comprise one or more storage devices. One or more components of computing system 200 (e.g., processing circuitry 243, memory 202) may be interconnected to enable inter-component communications (physically, communicatively, and/or operatively). In some examples, such connectivity may be provided by a system bus, a network connection, an inter-process communication data structure, local area network, wide area network, or any other method for communicating data. The one or more storage devices of memory 202 may be distributed among multiple devices.

Memory 202 may store information for processing during operation of computing system 200. In some examples, memory 202 comprises temporary memories, meaning that a primary purpose of the one or more storage devices of memory 202 is not long-term storage. Memory 202 may be configured for short-term storage of information as volatile memory and therefore not retain stored contents if deactivated. Examples of volatile memories include random access memories (RAM), dynamic random-access memories (DRAM), static random access memories (SRAM), and other forms of volatile memories known in the art. Memory 202, in some examples, may also include one or more computer-readable storage media. Memory 202 may be configured to store larger amounts of information than volatile memory. Memory 202 may further be configured for long-term storage of information as non-volatile memory space and retain information after activate/off cycles. Examples of non-volatile memories include magnetic hard disks, optical discs, Flash memories, or forms of electrically programmable memories (EPROM) or electrically erasable and programmable (EEPROM) memories. Memory 202 may store program instructions and/or data associated with one or more of the modules described in accordance with one or more aspects of this disclosure.

Processing circuitry 243 and memory 202 may provide an operating environment or platform for one or more modules or units (e.g., NNs 206), which may be implemented as software, but may in some examples include any combination of hardware, firmware, and software. Processing circuitry 243 may execute instructions and the one or more storage devices, e.g., memory 202, may store instructions and/or data of one or more modules. The combination of processing circuitry 243 and memory 202 may retrieve, store, and/or execute the instructions and/or data of one or more applications, modules, or software. The processing circuitry 243 and/or memory 202 may also be operably coupled to one or more other software and/or hardware components, including, but not limited to, one or more of the components illustrated in FIG. 2.

Processing circuitry 243 may execute reinforcement learning system 100 using virtualization modules, such as a virtual machine or container executing on underlying hardware. One or more of such modules may execute as one or more services of an operating system or computing platform. Aspects of reinforcement learning system 100 may execute as one or more executable programs at an application layer of a computing platform.

One or more input devices 244 of computing system 200 may generate, receive, or process input. Such input may include input from a keyboard, pointing device, voice responsive system, video camera, biometric detection/response system, button, sensor, mobile device, control pad, microphone, presence-sensitive screen, network, or any other type of device for detecting input from a human or machine.

One or more output devices 246 may generate, transmit, or process output. Examples of output are tactile, audio, visual, and/or video output. Output devices 246 may include a display, sound card, video graphics adapter card, speaker, presence-sensitive screen, one or more USB interfaces, video and/or audio output interfaces, or any other type of device capable of generating tactile, audio, video, or other output. Output devices 246 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 244 and one or more output devices 246.

One or more communication units 245 of computing system 200 may communicate with devices external to computing system 200 (or among separate computing devices of computing system 200) by transmitting and/or receiving data, and may operate, in some respects, as both an input device and an output device. In some examples, communication units 245 may communicate with other devices over a network. In other examples, communication units 245 may send and/or receive radio signals on a radio network such as a cellular radio network. Examples of communication units 245 may include a network interface card (e.g., such as an Ethernet card), an optical transceiver, a radio frequency transceiver, a GPS receiver, or any other type of device that can send and/or receive information. Other examples of communication units 245 may include Bluetooth®, GPS, 3G, 4G, and Wi-Fi® radios found in mobile devices as well as Universal Serial Bus (USB) controllers and the like.

In the example of FIG. 2, NN 206 may receive input data and may generate output data 212. Input data 210 and output data 212 may contain various types of information. For example, input data 210 may include a risk parameter received from a human modeler or proxy, probability space description, and/or problem specification. Output data 212 may include an indication of a decision, which may be a classification label; a numerical prediction; a recommended action; commands, signals, or other directives for other device or components of computing system; an action performed by computing system 200; or another indication of a decision, for example.

Each set of layers 208 may include a corresponding set of artificial neurons. Layers 208A for example, may include an input layer, a feature layer, an output layer, and one or more hidden layers. Layers 208 may include fully connected layers, convolutional layers, pooling layers, and/or other types of layers. In a fully connected layer, the output of each neuron of a previous layer forms an input of each neuron of the fully connected layer. In a convolutional layer, each neuron of the convolutional layer processes input from neurons associated with the neuron's receptive field. Pooling layers combine the outputs of neuron clusters at one layer into a single neuron in the next layer.

Each input of each artificial neuron in each layer of the sets of layers 208 is associated with a corresponding weight in weights 216. Various activation functions are known in the art, such as Rectified Linear Unit (ReLU), TanH, Sigmoid, and so on.

Reinforcement learning system 100 may process training data 213 to train the NN 206, in accordance with techniques described herein. For example, reinforcement learning system 100 may apply an end-to-end training method that includes processing training data 213. Reinforcement learning system 100 may process input data 210 to generate one or more decisions as described below.

In an aspect, risk-sensitive utility functions 250 may be tailored to be more or less sensitive to uncertainty. The risk parameter 152 may modulate the sensitivity of the utility function 250 to risk. With the higher risk parameter 152, AI agent 102 may become more risk-seeking, valuing potential high rewards over certain, lower-reward outcomes. With the lower risk parameter 152, AI agent 102 may become more risk-averse, prioritizing safety and avoiding high-risk decisions. The probability space, defined by the sigma algebra 156, may provide the framework for assessing risk. Different specifications of the sigma algebra 156 may lead to different risk profiles for the same decision problem. By considering the risk parameter 152 and the probability space, the AI agent 102 may make more informed decisions that align with risk preferences of the AI agent 102.

The present disclosure delves into the often-overlooked concept of o-algebra (sigma algebra 156) in the realm of decision-making, particularly within the context of RL. Sigma algebra 156 is a mathematical construct that may define a collection of events or subsets of a sample space. In simpler terms, sigma algebra 156 may specify what information is available to a decision-maker (in this case AI agent 102).

Traditionally, decision-making theories, including expected utility theory and standard RL algorithms, have largely disregarded the influence of sigma algebra 156 because the aforementioned theories and algorithms typically operate under the assumption of a “risk-neutral” decision-maker, where the choice of sigma algebra 156 does not impact the final decision. The disclosed techniques essentially challenge this conventional wisdom and introduce a framework that explicitly considers the role of sigma algebra 156 in decision-making processes. For AI agents 102 that are sensitive to risk, the choice of sigma algebra 156 may significantly influence decision-making of these AI agents 102. By incorporating the sigma algebra 156, the AI agent 102 may better capture the impact of uncertainty and risk on decision outcomes. In sequential decision problems like RL, the information available to the AI agent 102 at each step may vary. In one non-limiting example, by considering the sigma algebra 156 of the AI agent 102 at different time steps, the disclosed techniques may provide a more nuanced understanding of how information affects decision-making. When a decision-maker has access to complete information, the disclosed techniques may reduce to existing risk-sensitive stochastic programming frameworks.

In cases where the AI agent 102 has minimal information, the disclosed techniques may revert to the risk-neutral expected utility framework. However, for intermediate levels of information, the disclosed techniques may provide a framework for analyzing how different information structures influence decision-making. In the example illustrated in FIG. 2, reinforcement learning system 100 may adapt algorithms to varying levels of information and uncertainty.

The expectation of a random variable R may be represented by the following formula (1):

$$𝔼 [ R ] := {\sum }_{i = 1}^{n} R ( {ω}_{i} ) P ( {ω}_{i} ) \qquad ( 1 )$$

where: R(ωᵢ) is the value of the random variable for outcome ωᵢ, P(ωᵢ) is the probability of outcome ωᵢ.

The variance of a random variable R, denoted as [symbol] (R), is a measure of dispersion or spread of R. The variance of a random variable R quantifies how much the values of the random variable deviate from mean (expectation). The following formula (2) calculates the expected squared deviation from the mean:

$$𝕍 ( R ) := 𝔼 [ {( R - 𝔼 [ R ] )}^{2} ] \qquad ( 2 )$$

A more convenient formula for calculating variance is the following formula (3):

$$𝕍 ( R ) := 𝔼 [ {R}^{2} ] - {𝔼}^{2} [ R ] \qquad ( 3 )$$

The formula (3) involves calculating the expected value of the square of the random variable and subtracting the square of the expected value.

Conditional expectation, denoted as E[X|G], represents the expected value of a random variable X, given the information contained in a sigma algebra G. Conditional expectation is essentially a refinement of the traditional expectation, taking into account additional information.

E[X|G] may be seen as the best guess of X, given the knowledge encapsulated in G. Importantly, E[X|G] is itself a random variable, defined on the same probability space as X. Value of E[X|G] depends on the specific information revealed by G.

In accordance with the disclosed techniques, a partition of a sample space Ω is a collection of subsets {Ω₁, Ω₂, . . . , Ωₖ} such that: i) every outcome in Ω belongs to exactly one subset; ii) the subsets are pairwise disjoint. The sigma algebra 156 may represent a partition. In other words, the sigma algebra 156 generated by a partition contains all possible unions of these partition sets, as well as their complements and intersections. As used herein, when conditioning on sigma algebra 156 generated by a partition, the conditional expectation is constant within each partition cell. In other words, given the information that the outcome belongs to a specific partition cell, the best guess for X is the average value of X within that cell.

Conditional expectation may be represented by the following formula (4):

$$𝔼 [ R \vert Σ ] ( ω ) := {\sum }_{i = 1}^{k} 𝔼 [ R \vert {Ω}_{i} ] {𝟙}_{{Ω}_{i}} ( ω ) \qquad ( 4 )$$

The sample space Ω is divided into disjoint subsets Ω₁, Ω₂, . . . , Ωₖ. In one non-limiting example, each subset represents a specific event. The indicator function [symbol] _{Ω}_{₂}, equals 1 if ω belongs to the set Ωᵢ, and 0 otherwise. The indicator function essentially “turns on” the corresponding term in the sum when the outcome ω is in the partition cell Ωᵢ.

Conditional Expectation ( [symbol] [R|Ωᵢ]) represents the expected value of R, given that the outcome belongs to the specific partition cell Ωᵢ. Conditional expectation may be calculated as the expected value of R multiplied by the indicator function [symbol] _{Ω}_{ᵢ}, divided by the probability of the event Ωᵢ. The formula (4) may be used to calculate the conditional expectation of R, given the information contained in the sigma algebra Σ. Advantageously, formula (4) may consider each partition cell individually. For each cell Ωᵢ, the conditional expectation is a constant value, [symbol] [R|Ωᵢ]. The overall conditional expectation is a piecewise constant function, taking on the value [symbol] [R|Ωᵢ] for all outcomes ω in the cell Ωᵢ.

Trivial sigma algebra 156 contains only two sets: the empty set (Ø) and the entire sample space (Ω). No information means there is no information about the outcome of the random experiment. The best guess for the value of the random variable R, given no information, is simply its unconditional expectation [symbol] [R]. In one example, full information sigma algebra 156 contains all possible subsets of the sample space.

Perfect information is available when the exact outcome of the random experiment is known. In this case, the best guess for R is the actual value of R itself. The conditional expectation of R, given no information, is equal to the unconditional expectation of R, which may be represented by the following formula (5):

$$𝔼 [ R \vert {Σ}_{0} ] = 𝔼 [ R ] \qquad ( 5 )$$

The conditional expectation of R, given perfect information, is equal to R itself, which may be represented by formula (6):

$$𝔼 [ R \vert {2}^{Ω} ] = R \qquad ( 6 )$$

Unbiased estimator property of total expectation states that the expected value of the conditional expectation is equal to the unconditional expectation. No matter how the sample space is partitioned, the average of the conditional expectations will always equal the overall average.

Convex functions curve upwards. Examples of convex functions include, but are not limited to, x², |x|, and exp(x). Jensen's inequality states that the expected value of a convex function of a random variable is greater than or equal to the convex function of the expected value. Conditional version extends Jensen's inequality to conditional expectations: the conditional expectation of a convex function is greater than or equal to the convex function of the conditional expectation. The conditional expectation R̅ is measurable with respect to the sigma algebra Σ. In other words, value of the conditional expectation may be determined solely by the information contained in Σ.

When multiplying R with R̅, R̅ can be “pulled out” from the conditional expectation, as the conditional expectation is already measurable with respect to Σ. L^{p} space property relates to the L^{p} norm of random variables. The conditional expectation operator is a contraction mapping. In other words, the conditional expectation operator shrinks the L^{p} norm of a random variable. Conditioning on sigma algebra 156 may only reduce the variability of a random variable.

Conditioning on sigma algebra 156 reduces the variance of a random variable.

In an example, conditioning on sigma algebra 156, essentially means grouping outcomes together based on the information available. This reduces the variability within each group. The conditional expectation within each group may be the best guess for the value of the random variable, given the information in that group. This reduces the uncertainty.

Variance reduction inequality may be represented by the following formula (7):

$$𝕍 ( R ) \geq 𝕍 ( 𝔼 [ R \vert Σ ] ) , ∀ Σ \qquad ( 7 )$$

This inequality states that the variance of the original random variable R is greater than or equal to the variance of its conditional expectation [symbol] [R|Σ]).

Uncertainty is a common challenge in many real-world decision-making problems. For example, retailers trying to decide how many winter coats to order for the upcoming season face uncertainty. The retailers do not know for sure how cold the winter will be, or how many customers will want to buy a coat. Single-stage stochastic programs are tools that may be employed to help make the decision in such uncertain situations.

In single-stage stochastic programs, decision variable is the variable that can be controlled, such as the number of coats to order. Random variable represents the uncertain factor, such as the temperature or customer demand in the above example.

Objective function is the quantity that needs optimization, such as profit or cost. The objective function may be a function of both the decision and the random variable. Risk measure is a mathematical function that quantifies the risk associated with a particular decision. Common risk measures include, but are not limited to, expectation and entropic risk measure. Expectation is the average outcome. Entropic risk measure is a measure that considers both the expected value and the variability of the outcome.

The objective of a single-stage stochastic program is to find the value of the decision variable that minimizes (or maximizes) the expected value of the objective function, while also considering the risk associated with different decisions. While the expectation provides a useful measure of central tendency, the expectation does not capture the variability or uncertainty in the outcome. In some implementations, risk measures like the entropic risk measure may help focus on extreme events, such as very cold winters or high demand, which may have a significant impact on decision-making.

Probability space may be represented as (Ω, Σ, P). Ω is the sample space, representing all possible outcomes. Σ is the sigma-algebra, defining the set of events on Ω. P is the probability measure, assigning probabilities to events in Σ. Random variable R is a function that maps outcomes in Ω to real numbers. Linear space [symbol] is a space of random variables, like L^{p} spaces, which are commonly used in probability theory. Decision variable x is an element from the admissible decision set X. The decision x may influence the distribution of R. In other words, different choices of x may lead to different probability distributions for R.

Additionally, risk measure J(⋅) is a function that quantifies the risk associated with a random variable. Expectation is a simple risk measure, but expectation does not capture the variability.

Variance measures the dispersion of the random variable. Entropic risk measure is a measure that considers both the mean and the tail risk. The optimal decision x* that maximizes (or minimizes) the risk measure J(R^{x}) may be represented by formula (8):

$${x}^{*} = arg {max}_{x ∈ X} J ( {R}^{x} ) \qquad ( 8 )$$

By using appropriate risk measures, the decision makers may quantify and manage the uncertainty. Formula (8) represents a single stage stochastic program. While single-stage programs do not allow for real-time adjustments, the single-stage programs may provide a valuable framework for making strategic decisions in advance.

In the realm of stochastic programming, the choice of risk measure may significantly influence the decision-making process.

Risk-neutral stochastic programs minimize or maximize the expected value of a random variable. It should be noted, risk-neutral stochastic programs ignore risk, focusing solely on the average outcome.

Risk-sensitive stochastic programs minimize or maximize a risk-adjusted objective function. Risk-sensitive stochastic programs account for both the expected value and the risk associated with different decisions. Common risk measures include mean-variance and entropic risk measure. Risk-neutral programs prioritize the average outcome, neglecting the variability. Risk-sensitive programs consider both the average and the dispersion of the outcomes, allowing for a more nuanced decision-making process.

Risk-neutral programs may lead to decisions that are optimal in terms of average performance but expose the decision-maker to significant risk. Risk-sensitive programs can help mitigate risk by incorporating risk measures that penalize uncertainty.

According to the disclosed techniques, the reinforcement learning system 100 may leverage the concept of a sigma algebra 156 and risk parameters 152 to refine the decision-making process. As noted above, the sigma algebra 156 is a mathematical construct that defines the set of events or outcomes. In this example, in the context of AI, the sigma algebra 156 may help to structure the uncertainty space.

By considering different sigma algebras 156, the AI agent 102 may adapt to various levels of information and uncertainty. Furthermore, risk parameter 152 is a numerical value that influences the risk tolerance of the AI agent 102.

In one non-limiting example, a higher risk parameter 152 may indicate a greater willingness to take risks, while a lower value may imply a more conservative approach. The risk parameter 152, in conjunction with the sigma algebra 156, may shape the decision-making process. In one example, the AI agent 102 may employ an exponential utility function 250. In another example, AI agent 102 may employ a combination of expected utility and variance.

Exponential utility function 250 is a function used in decision theory and risk management. Exponential utility function 250 assigns higher utility to certain outcomes, especially those that are significantly better than the average.

As noted above, the combination of expected utility and variance technique may consider both the average outcome and its variability. By combining these two factors, the AI agent 102 may make more informed decisions, balancing potential rewards with risk.

The AI agent 102, equipped with the sigma algebra 156 and risk parameter 152 may evaluate potential actions by calculating their expected utility. The choice of utility function 250 (exponential or combined) may determine how the AI agent 102 weighs different outcomes. The AI agent 102 employing the exponential utility function 250 may be more sensitive to extreme outcomes, both positive and negative. This may lead to more aggressive or conservative decisions, depending on the specific context and the risk parameter 152. The AI agent 102 employing the combined utility function 250 may consider both the average outcome and variability of the outcome. The latter technique may allow for a more balanced decision-making process, avoiding overly risky or overly conservative choices.

In one non-limiting example, AI agent 102 may make decisions based on probabilistic information and risk preferences. AI agent 102 may integrate input received from multiple sources. In an aspect, a human modeler or proxy may provide the risk parameter 152. The value of the risk parameter 152 may quantify the risk tolerance of the AI agent 102.

In an aspect, the risk parameter 152 may be tuned to indicate a degree of risk aversive behavior of the AI agent 152 or a degree of risk seeking behavior of the AI agent 152. In one example, a higher value of the risk parameter 152 may indicate a willingness to take more risks, while a lower value of the risk parameter 152 may suggest a more conservative approach. The risk parameter 152 input may allow the AI agent 102 to tailor decisions of the AI agent 102 to the specific risk preferences of the human decision-maker.

It should be noted that sigma algebra 156 may be a customizable parameter as well. The sigma algebra 156 may be generated from a smaller collection of sets, known as a generating set. This generating set may be tailored to specific needs, providing flexibility in defining the events of interest. In one example, a human expert, such as, but not limited to, a statistician or domain specialist, may define the generating set based on their knowledge and the specific problem AI agent 102 is trying to solve. For example, a meteorologist may define a sigma algebra on a sample space of weather conditions, with events such as, but not limited to, “rain,” “snow,” or “sunny.” In an aspect, another AI agent, different from AI agent 102 may be trained for machine learning or statistical analysis, may be trained to learn from data and automatically identify relevant events. For instance, an AI agent analyzing customer behavior data may create a sigma algebra with events like “high-value customer,” “frequent purchaser,” or “product returner.” In yet another example, a system designer may predefine a sigma algebra based on common use cases or industry standards. For example, a financial analyst may use a predefined sigma algebra 156 for stock market analysis, with events such as, but not limited to, “stock price increase,” “market crash,” or “economic recession.” Furthermore, a domain expert may provide insights into the relevant events and their relationships, helping to refine the sigma algebra 156. For example, a medical researcher may work with a statistician to define a sigma algebra for clinical trial data, considering events like “patient recovery,” “adverse side effects,” or “treatment efficacy.” In summary, the customizability of sigma algebras 156 may enable tailoring probabilistic models to specific domains and applications. By carefully selecting the generating set, a framework may be created that accurately captures the uncertainty and variability inherent in real-world phenomena.

In the example illustrated in FIG. 2, Information Processing System (IPS) 254 may provide the AI agent 102 with information about the possible outcomes of a random process and associated probabilities of the possible outcomes. This information may be important for assessing the potential risks and rewards of different decisions.

In this case, the IPS 254 may generate multiple sigma algebras 156, each representing a different level of information granularity. Such flexibility may allow the AI agent 102 to adapt to varying levels of uncertainty and complexity. In one example, IPS 254 may be a component of the computing system 200.

In an aspect, IPS 254 may also define the specific decision-making task, such as, but not limited to, classification, regression, or optimization. More specifically, the decision-making task defined by IPS 254 may guide the AI agent 102 in selecting the appropriate decision-making strategy and performance metric.

In one example, the AI agent 102 may receive the risk parameter 152, probability space description, and problem specification from the respective sources. The AI agent 102 may employ utility function 250, such as, but not limited to, the exponential utility or a combination of expected utility and variance, to quantify the desirability of different outcomes. The AI agent 102 may consider the risk parameter 152 and the probability distribution to make a decision that balances potential rewards and risks. The sigma algebra 156 and probability function may play an important role in this process. The AI agent 102 may output a decision, which may be a classification label, a numerical prediction, or a recommended action.

Advantageously, the disclosed system may adapt to various decision-making scenarios by adjusting the risk parameter 152 and the level of detail in the sigma algebra 156. The use of multiple sigma algebras 156 may allow the AI agent 102 to handle uncertainty and make informed decisions even in the presence of limited information.

It should be noted that the decision-making process of AI agent 102 may be significantly influenced by the sigma algebra 156 and the risk parameter 152 provided as input data 210.

With respect to the sigma algebra 156, the sigma algebra 156 may determine the level of detail with which the AI agent 102 may perceive the environment 106. In this example, a finer-grained sigma algebra 156 may provide more precise information, enabling the AI agent 102 to make more nuanced decision. The sigma algebra 156 may help quantify uncertainty associated with different outcomes. This information may be important for assessing risk and making informed choices.

It should be noted that the sigma algebra 156 may define the set of possible events and probabilities of the possible events. The set of possible events, in turn, may shape the decision space of the AI agent 102, influencing the range of feasible actions.

The risk parameter 152 may reflect the willingness of the AI agent 102 to take on risk. A higher risk parameter 152 may indicate a greater tolerance for uncertainty and potential losses. As noted above, a higher risk parameter 152 may lead the AI agent 102 to favor options with higher expected rewards, even if the options involve greater risk. Conversely, a lower risk parameter 152 may bias the AI agent 102 towards more conservative choices.

As discussed previously, the risk parameter 152 may help the AI agent 102 balance the trade-off between potential rewards and risks. The risk parameter 152 may allow the AI agent 102 to adjust the decision-making strategy based on the specific context and the desired level of risk exposure.

In this context, the sigma algebra 156 may define the set of all possible events and their probabilities. Probability distribution may assign probabilities to each event in the sigma algebra 156. The sample space may be the set of all possible outcomes of a random process.

Data samples may be realizations of the random process. At the same time, the risk parameter 152 may be a numerical value indicating the risk tolerance of the AI agent 102. In one possible implementation, the risk parameter 152 may be provided by a human operator or a human modeler. An exponential utility function 250 may emphasize risk aversion, assigning higher values to certain outcomes over uncertain ones. The expected utility and variance function may balance expected rewards and risk, considering both the mean and the variability of potential outcomes. The exponential utility function 250 may be extended to consider data samples by incorporating the data samples into the calculation of the outcome (e.g., the decision variable x). For example, if the AI agent 102 is making a decision based on historical data, the outcome x could be a function of the predicted future value of a variable, derived from the data. Considering an illustrative example of AI agent 102 trading stocks, the AI agent 102 might use an exponential utility function to evaluate different investment strategies. The outcome (decision) x could be the potential return on investment, and the risk aversion parameter r may be adjusted based on the risk tolerance of the AI agent 102. By analyzing historical data, the AI agent 102 may estimate the probability distribution of potential returns and may calculate the expected utility of each strategy.

The AI agent 102 may formulate an optimization problem that is configured to maximize the utility function 250, subject to the constraints imposed by the probability space, risk parameter 152, and data samples. The AI agent 102 may solve the optimization problem to determine the optimal decision. In an aspect, the decision may be a choice in a gamble or a more complex action.

It should be noted that the risk parameter 152 may directly impact the decision-making of the AI agent 102. A higher risk parameter 152 may lead to risk-seeking behavior, while a lower risk parameter may encourage risk-averse choices. The sigma algebra 156 may determine the granularity of information available to the AI agent 102.

Expected utility theory is a framework that may be used to explain how rational decision-makers make choices under uncertainty. AI agent 102 employing expected utility function 250 may assign a utility value to each potential outcome. The utility value may represent the subjective value or satisfaction that AI agent 102 may derive from a particular outcome. In an aspect, the utility function 250 may assign a numerical value to each possible outcome, reflecting the preferences of the AI agent 102. A higher utility value may indicate a more preferred outcome. Expected utility is the weighted average of the utilities of all possible outcomes, where the weights are the probabilities of those outcomes occurring. A rational AI agent 102 is an agent who essentially always chooses the option with the highest expected utility. In an aspect, the AI agent 102 may first identify all the potential outcomes of each decision. The AI agent 102 may assign a utility value to each outcome based on personal preferences. The AI agent 102 may estimate the probability of each outcome occurring. For each decision, the AI agent 102 may calculate the expected utility by multiplying the utility of each outcome by probability of the outcome and summing the results. The AI agent 102 may select the decision with the highest expected utility.

In one non-limiting example, the AI agent 102 may be tasked to make a decision whether to invest in a risky stock or a safe bond. In this example, the risky stock may provide high potential return (high utility) and high probability of loss (low utility). In contrast, the safe bond may provide low potential return (low utility) and low probability of loss (high utility). A rational AI agent 102 may calculate the expected utility of both options and may choose the one with the higher value.

The expected utility theory posits that a rational AI agent may be configured to maximize the expected utility. This may be expressed as formula (9):

$${x}^{*} = {arg max}_{x ∈ X} 𝔼 [ u ( {R}^{x} ) ] \qquad ( 9 )$$

where:
x is a decision variable,
[symbol] is a feasible decision space,
R^{x} ia a random variable representing the outcome of decision x,
u(⋅) is utility function 250, mapping outcomes to utility values,
[symbol] [⋅]: is the expectation operator.
   A risk-neutral AI agent 102 may be indifferent to risk. In other words, the risk-neutral AI agent 102 may be solely concerned with the expected value of a random variable, regardless of variance of the random variable. Mathematically, this may be represented by formula (10) of the linear utility function 250:

$$u ( x ) = x \qquad ( 10 )$$

The substitution of the linear utility function 250 (10) into the expected utility maximization problem (9) may be expressed by formula (11):

$${x}^{*} = {arg max}_{x ∈ X} 𝔼 [ x ] \qquad ( 11 )$$

Since [symbol] [x] is the expected value of the random variable R^{x}, the formula (11) may be simplified to formula (12):

$${x}^{*} = {arg max}_{x ∈ X} 𝔼 [ ( {R}^{x} ) ] \qquad ( 12 )$$

Formula (12) is precisely the objective function of a risk-neutral stochastic programming problem. In essence, expected utility theory provides a general framework for decision-making under uncertainty. Risk neutrality is a specific preference towards risk, where the AI agent 102 is indifferent to risk.

An exponential utility function 250 introduces risk sensitivity. The exponential utility function 250 may be expressed by formula (13):

$$u ( x ) = β {e}^{β x} \qquad ( 13 )$$

where:
β is a risk parameter.

The value of β may determine the degree of risk aversion or risk-seeking behavior. In an example, a negative β (B<0) may indicate risk aversion. As β becomes more negative, the AI agent 102 may become more risk-averse. A positive β (β>0) may indicate risk-seeking behavior. As β becomes more positive, the AI agent 102 may become more risk-seeking. As β approaches 0 (β=0), the exponential utility function 250 may converge to a linear function, leading to risk-neutral behavior. Substitution of the exponential utility function (13) into the expected utility maximization problem, produces formula (14):

$${x}^{*} = {arg max}_{x ∈ X} 𝔼 [ β {e}^{β {R}^{x}} ] \qquad ( 14 )$$

Formula (14) represents a risk-sensitive objective function. The term [symbol] [βe^{βR}^{^{x}}] is not a simple expectation, but rather a risk-sensitive measure that incorporates both the mean and variance of the random variable R^{x}. The risk-sensitive objective function balances the trade-off between expected return and risk. A negative β penalizes variability, leading to risk-averse behavior. A positive β rewards variability, leading to risk-seeking behavior.

Non-linear utility functions 250, such as, but not limited to the exponential utility function 250 discussed earlier, may capture some aspects of risk-sensitive behavior, including risk aversion and risk-seeking. However, non-linear utility functions 250 may have limitations. Non-linear utility functions 250 primarily capture risk preferences through the curvature of the utility function. While this may capture some risk-sensitive behavior, the curvature of the utility function 250 may not be sufficient to capture all nuances of risk. Calibrating non-linear utility functions 250 to specific risk preferences may be challenging, especially when dealing with complex decision problems. The mean-variance formulation is a well-established risk measure that considers both the expected return (mean) and the variability (variance) of a random variable. The mean-variance formulation offers a more comprehensive technique to risk management, as the mean-variance allows for a trade-off between risk and return. While non-linear utility functions 250 may implicitly capture some aspects of mean-variance trade-offs, the non-linear utility functions often lack the explicit and flexible control offered by the mean-variance formulation. Value at Risk (VaR) measures the potential loss in the worst-case scenario with a certain probability. Conditional Value at Risk (CVaR) measures the expected loss beyond a certain threshold. Expected Shortfall (ES) is similar to CVaR, but often more robust. Entropic risk measure is a measure based on information theory, which may capture both risk aversion and risk-seeking behavior.

Advantageously, the mean-variance risk measure is a technique to incorporate risk into decision-making under uncertainty. The mean-variance risk measure may balance the expected return (mean) with the risk associated with the return (variance). In an aspect, AI agent 102 may solve the corresponding optimization problem, which may be expressed as formula (15):

$${x}^{*} = {arg max}_{x ∈ X} 𝔼 [ {R}^{x} ] - λ𝕍 ( {R}^{x} ) \qquad ( 15 )$$

where:
x is a decision variable,
[symbol] is a feasible decision space,
R^{x} is the random variable representing the outcome of decision x,
[symbol] [R^{x}] is the expected value of R^{x},
[symbol] (R^{x}) is the variance of R^{x},
λ is the risk aversion parameter.
λ=0 represents a risk-neutral behavior, where only the expected return is considered. λ>0 represents a risk-averse behavior, where a higher value of λ indicates stronger risk aversion. By adjusting the value of λ, the trade-off between expected return and risk may be controlled. A higher λ penalizes variance more heavily, leading to more conservative decisions. The connection between exponential utility and mean-variance may be seen through a Taylor series expansion of the exponential function. By approximating the exponential function with a second-order Taylor series, a relationship between the expected exponential utility and the mean-variance may be formulated.

In other words, the variance measures the dispersion or spread of the utility values. A higher variance indicates greater uncertainty or risk. By adding a penalty term based on the variance, the AI agent 102 may favor decisions that lead to more consistent and predictable outcome. In this case, λ is a regularization parameter (controls the weight of the variance penalty). Advantageously, regularizing the expected utility function with the variance of the utility values conditioned on the sigma algebra may provide a framework for AI agent 102 to make informed decisions under uncertainty, taking into account both the expected rewards and the associated risks.

There are many applications for the disclosed techniques, including AI assistants in many fields such as, but not limited to the following: AI assistants in the military, AI assistants for aging populations, AI assistants for people suffering from substance abuse, AI assistants for medical applications, and AI assistants for psychological applications. The AI assistants in the military may be used to help with a wide variety of tasks from logistics and decision-making to training and surveillance. The AI assistants in the military may be used to develop new military strategies and tactics. The AI assistants for aging populations may help with tasks such as, but not limited to, managing finances, scheduling appointments, and providing companionship. The AI assistants for aging populations could also be used to monitor the health of older adults and alert caregivers to any potential problems. The AI assistants for people suffering from substance abuse may provide support and encouragement to people who are trying to overcome addiction. The AI assistants for people suffering from substance abuse may also be used to track progress and identify potential triggers for relapse. The AI assistants for medical applications may be used to help with various tasks from diagnosis and treatment to patient education and research. The AI assistants for medical applications may also be used to develop new medical treatments and therapies. Furthermore, AI assistants may play a valuable role in medical triage by quickly assessing a patient's condition and determining the appropriate level of care. For example, by processing information about symptoms, pain levels, heart rate, blood pressure, and other vital signs, AI assistants may assess the severity of the patient's condition. By analyzing symptom combinations and patterns, AI assistants may identify high-risk conditions that may require immediate medical attention. The AI assistants for psychological applications may be used to help with tasks ranging from mental health counseling to stress management and self-improvement. The AI assistants for psychological applications could also be used to develop new psychological treatments and therapies.

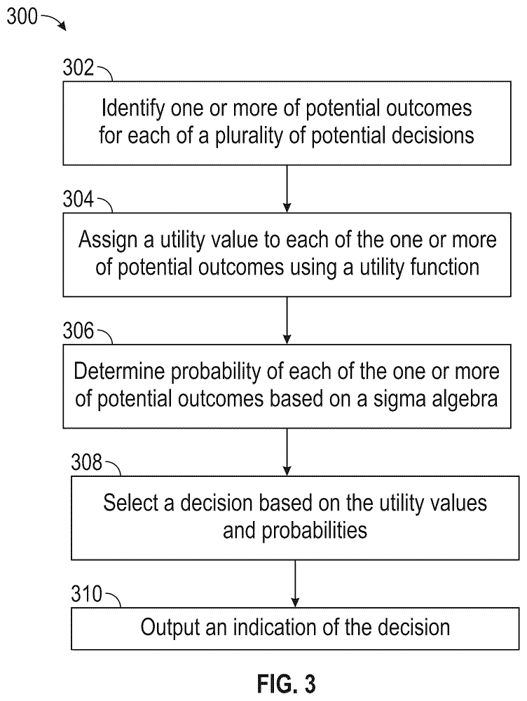

FIG. 3 is a flowchart illustrating an example mode of operation for a reinforcement learning system, according to techniques described in this disclosure. Although described with respect to computing system 200 of FIG. 2 having processing circuitry 243 that executes reinforcement learning system 102, mode of operation 300 may be performed by a computing system with respect to other examples of machine learning systems described herein.

In mode of operation 300, processing circuitry 243 executes reinforcement learning system 102. An Artificial Intelligence (AI) agent 102 may process an explored state space of an environment to identify one or more of potential outcomes for each of a plurality of potential decisions (302). In an aspect, the AI agent 102 may analyze the possible scenarios or states the environment 106 may be in. This step may involve identifying all potential outcomes that could arise from a plurality of different decisions. The AI agent 102 may assign a utility value to each of the one or more of potential outcomes of each of the plurality of potential decisions using a utility function 250 (304). The utility function 250 may depend on risk parameter 152 indicative of a specified risk preference of the AI agent 102. In an aspect, this utility value may represent the desirability of that outcome from the perspective of the AI agent 102. As used herein, the risk parameter 152 may reflect the tolerance of the AI agent 102 for risk. A higher risk parameter 152 may mean the AI agent 102 is more willing to take chances for potentially higher rewards. Next, the AI agent 102 may determine probability of each of the one or more of potential outcomes occurring for each of the plurality of potential decisions based on a sigma algebra (306). A specification of the probability space may include sigma algebra 156 defining a set of events that may occur in the environment (a set of possible events). The AI agent 102 may select a decision from the plurality of potential decisions based on the utility values and probabilities (308). The selected decision may align with the specified risk preference of the AI agent 102. In an aspect, the AI agent 102 may make a decision by considering both the utility and probability of each potential outcome. Advantageously, AI agent 102 may select the decision that maximizes the expected utility, taking into account the risk preference of the AI agent 102. Finally, AI agent 102 may communicate (e.g., output) an indication of the chosen decision to the external environment (310) or may execute the chosen decision directly by performing a certain action, for example.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for decision-making by an Artificial Intelligence (AI) agent based on risk attitude, the method comprising:
processing, by the AI agent, an explored state space of an environment to identify one or more potential outcomes for each of a plurality of potential decisions;
assigning, by the AI agent, based on a utility function, a utility value to each of the one or more potential outcomes for each of the plurality of potential decisions, wherein the utility function depends on a risk parameter indicative of a specified risk preference of the AI agent;
determining, by the AI agent, based on a predefined sigma algebra defining a set of events that may occur in the environment, a probability of each of the one or more potential outcomes occurring for each of the plurality of potential decisions;
selecting, by the AI agent, a decision from the plurality of potential decisions based on the utility values and the probabilities; and
outputting, by the AI agent, an indication of the decision.

2. The method of claim 1, wherein the sigma algebra represents a partition of a sample space.

3. The method of claim 2, wherein the sigma algebra is selected based on the specified risk preference of the AI agent.

4. The method of claim 2, wherein the sigma algebra comprises a configurable parameter.

5. The method of claim 1, wherein the risk parameter may be tuned to indicate a degree of risk aversive behavior of the AI agent or a degree of risk seeking behavior of the AI agent.

6. The method of claim 1, wherein the utility function is an exponential function of the risk parameter and a data sample.

7. The method of claim 1, wherein the utility function is an expected utility function regularized by the variance of the utility values conditioned on the sigma algebra.

8. The method of claim 1, wherein outputting the indication of the decision comprising performing, by the AI agent, an action.

9. A computing system for decision-making by an Artificial Intelligence (AI) agent based on risk attitude, the computing system comprising:
processing circuitry in communication with storage media, the processing circuitry configured to execute a machine learning system comprising the AI agent, the machine learning system configured to:
process an explored state space of an environment to identify one or more potential outcomes for each of a plurality of potential decisions;
assign, based on a utility function, a utility value to each of the one or more potential outcomes for each of the plurality of potential decisions, wherein the utility function depends on a risk parameter indicative of a specified risk preference of the AI agent;
determine, based on a predefined sigma algebra defining a set of events that may occur in the environment, a probability of each of the one or more potential outcomes occurring for each of the plurality of potential decisions;
select a decision from the plurality of potential decisions based on the utility values and the probabilities; and
output an indication of the decision.

10. The system of claim 9, wherein the sigma algebra represents a partition of a sample space.

11. The system of claim 10, wherein the sigma algebra is selected based on the specified risk preference of the AI agent.

12. The system of claim 10, wherein the sigma algebra comprises a configurable parameter.

13. The system of claim 9, wherein the risk parameter may be tuned to indicate a degree of risk aversive behavior of the AI agent or a degree of risk seeking behavior of the AI agent.

14. The system of claim 9, wherein the utility function is an exponential function of the risk parameter and a data sample.

15. The system of claim 9, wherein the utility function is an expected utility function regularized by the variance of the utility values conditioned on the sigma algebra.

16. The system of claim 9, wherein the machine learning system configured to output the indication of the decision is further configured to:
perform an action.

17. Non-transitory computer-readable storage media having instructions encoded thereon for decision-making by an Artificial Intelligence (AI) agent based on risk attitude, the instructions configured to cause processing circuitry to:
process an explored state space of an environment to identify one or more potential outcomes for each of a plurality of potential decisions;
assign, based on a utility function, a utility value to each of the one or more potential outcomes for each of the plurality of potential decisions, wherein the utility function depends on a risk parameter indicative of a specified risk preference of the AI agent;
determine, based on a predefined sigma algebra defining a set of events that may occur in the environment, a probability of each of the one or more potential outcomes occurring for each of the plurality of potential decisions;
select a decision from the plurality of potential decisions based on the utility values and the probabilities; and
output an indication of the decision.

18. The storage media of claim 17, wherein the sigma algebra represents a partition of a sample space.

19. The storage media of claim 18, wherein the sigma algebra is selected based on the specified risk preference of the AI agent.

20. The storage media of claim 18, wherein the sigma algebra comprises a configurable parameter.
